(19) United States
(12) Patent Application Publication
(10) Pub. No.: US 2007/0135603 A1
(43) Pub. Date: Jun. 14, 2007

(54) Film, film forming composition and electronic device having the film

(75) Inventor: Akira Asano, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/636,639

(22) Filed: Dec. 11, 2006

(30) Foreign Application Priority Data
Dec. 9, 2005 (JP) 2005-356781

(51) Int. Cl. C08F 32/08

(52) U.S. Cl. 526/280; 526/285

(57) ABSTRACT

A film having, as a result of raman spectroscopy, the highest intensity peak within from 690 to 800 cm⁻¹ in a Raman shift range of from 300 to 3100 cm⁻¹; a film forming composition capable of forming, the film; and an electronic device having the film.

### BACKGROUND OF THE INVENTION

1. Field of the Invention

The present invention relates to a film forming composition, more specifically, an insulating film forming composition to be used for electronic devices and excellent in film properties such as dielectric constant, mechanical strength and heat resistance. The invention also pertains to electronic devices having an insulating film obtained using the composition.

2. Description of the Related Art

In recent years, with the progress of high integration, multifunction and high performance in the field of electronic materials, circuit resistance and condenser capacity between interconnects have increased and have caused an increase in electric power consumption and delay time. Particularly, the increase in delay time becomes a large factor for reducing the signal speed of devices and generating crosstalk. Reduction of parasitic resistance and parasitic capacity are therefore required in order to reduce this delay time, thereby attaining speed-up of devices. As one of the concrete measures for reducing this parasitic capacity, an attempt has been made to cover the periphery of an interconnect with a low dielectric interlayer insulating film. The interlayer insulating film is expected to have superior heat resistance in the thin film formation step when a printed circuit board is manufactured or in post steps such as chip connection and pin attachment and also chemical resistance in the wet process. In addition, a low resistance Cu interconnect has been introduced in recent years instead of an A1 interconnect, and accompanied by this, CMP (chemical mechanical polishing) has been employed commonly for planarization of the film surface. Accordingly, an insulating film having high mechanical strength and capable of withstanding this CMP step is required.

As a highly heat-resistant insulating film, polybenzoxazole or polyimide films have been known widely for long years. Highly heat-resistant insulating films made of a polyarylene ether are also disclosed (in U.S. Pat. No. 6,380,347 and U.S. Pat. No. 5,965,679). There is however an eager demand for reducing the dielectric constant of the film in order to realize a high-speed device.

A polymer having, as a main component, a saturated hydrocarbon such as polyethylene features a low dielectric constant because it has a structure with small electronic polarization. However, since it is composed of a carbon-carbon single bond having a small bond dissociation energy, it usually has low resistance, which poses a problem.

Under various investigations, there is therefore a demand for the provision of a film excellent in heat resistance and mechanical strength as well as having a low dielectric constant.

### SUMMARY OF THE INVENTION

The present invention relates to a film forming composition capable of overcoming the above-described problems. More specifically, the invention provides, a film used for electronic devices and having an excellent heat resistance and an excellent mechanical strength as well as a low dielectric constant, a film forming composition capable of forming the film, and an electronic device having the film.

It has been found that the above-described problems can be overcome by the below-described constitutions <1> to <20>.

<1> A film having, as a result of Raman spectroscopy, the highest intensity peak within from 690 to 800 cm⁻¹ in a Raman shift range of from 300 to 3100 cm⁻¹.

<2> The film as described in above <1>, wherein the highest intensity peak is attributable to a —C—C— bond.

<3> The film as described in above <1>, wherein, as a result of Raman spectroscopy, a peak intensity existing within from 1500 to 2000 cm⁻¹ attributable to a —C═C— bond or aromatic structure is not greater than 0.7 time the highest peak intensity in a Raman shift range of from 300 to 3100 cm⁻¹.

<4> The film as described in above <1>, which comprises a compound having a cage structure

<5> The film as described in above <4>, wherein the compound having a cage structure is a polymer of a monomer having a cage structure.

<6> The film as described in above <4>, wherein the monomer having a cage structure has a polymerizable carbon-carbon double bond or carbon-carbon triple bond.

<7> The film as described in above <4>, wherein the cage structure is selected from the group consisting of adamantane, biadamantane, diamantane, triamantane and tetraamantane.

<8> The film as described in above <5>, wherein the monomer having a cage structure is a compound represented by any one of formulas (I) to (VI):

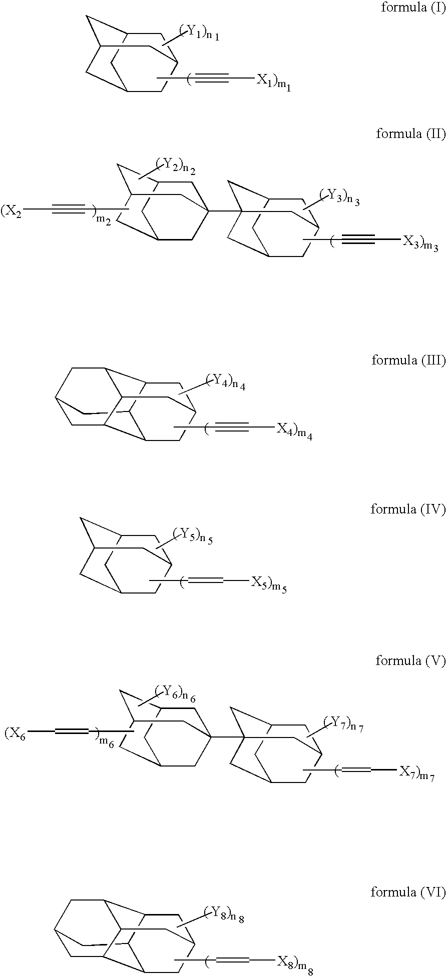

wherein, X₁ to X₈ each independently represents a hydrogen atom, alkyl group, alkenyl group, alkynyl group, aryl group, silyl group, acyl group, alkoxycarbonyl group or carbamoyl group; Y₁ to Y₈ each independently represents an alkyl group, aryl group or silyl group; m₁ and m₅ each independently represents an integer of from 1 to 16; n₁ and n₅ each independently represents an integer of from 0 to 15; m₂, m₃, m₆ and m₇ each independently represents an integer of from 1 to 15; n₂, n₃, n₆ and n₇ each independently represents an integer of from 0 to 14; m₄ and m₈ each independently represents an integer of from 1 to 20; and n₄ and n₈ each independently represents an integer of from 0 to 19.

<9> The film as described in above <4>, wherein the compound having a cage structure is obtained by polymerizing monomers having a cage structure in the presence of a transition metal catalyst or a radical initiator.

<10> The film as described in above <4>, wherein the compound having a cage structure has a solubility at 25° C. of 3 mass % or greater in cyclohexanone or anisole.

<11> The film as described in above <1>, which has insulation properties obtained by baking.

<12> An electronic device comprising a film as described in above <1>.

<13> A film forming composition comprising an organic solvent and capable of providing a film as described in above <1>.

<14> The film forming composition as described in above <1>, comprising a compound having a cage structure.

<15> The film forming composition as described in above <14>, wherein the compound having a cage structure is a polymer of a monomer having a cage structure.

<16> The film forming composition as described in above <15>, wherein the monomer having a cage structure has a polymerizable carbon-carbon double bond or carbon-carbon triple bond.

<17> The film forming composition as described in above <14>, wherein the cage structure is selected from the group consisting of adamantane, biadamantane, diamantane, triamantane and tetraamantane.

<18> The film forming composition as described in above <15>, wherein the monomer having a cage structure is a compound represented by any one of above-described formulas (I) to (VI).

<19> The film forming composition as described in above <15>, wherein the compound having a cage structure is obtained by polymerizing the monomer having a cage structure in the presence of a transition metal catalyst or a radical initiator.

<20> The film forming composition as described in above <15>, wherein the compound having a cage structure has a solubility at 25° C. of 3 mass % or greater in cyclohexanone or anisole.

### BRIEF DESCRIPTION OF THE DRAWINGS

FIG. 1 illustrates a Raman spectrum of the film of Polymer (A) in Example 1; and

FIG. 2 illustrates a Raman spectrum of the film of Polymer (A) in Example 1 after baking.

### DETAILED DESCRIPTION OF THE INVENTION

The present invention will hereinafter be described specifically.

An interlayer insulating film in electronic devices is desired to have a low dielectric constant and at the same time, have excellent heat resistance and mechanical strength. (An “insulating film” is also referred to as a “dielectric film” or a “dielectric insulating film”, and these terms are not substantially distinguished.) In the invention, it has been found that a film exhibiting a specific spectrum in Raman spectroscopy is good in the above-described properties.

When a low dielectric constant material is designed, use of, as a main component, a —C—C— bond having a low polarizability and use of carbon atoms, which constitute the material, similar in chemical environments (such as bond length, bond angle, kind of elements to be bound, and the number of elements to be bound) to some extent are presumed to prevent local concentration of a mechanical stress and improve the mechanical strength of the material. Diamond can be given as a substance having such properties, but is not suited as a low dielectric constant material because it has a dielectric constant as high as about 5.7. This is presumed to result from an increase in density owing to the absence of hydrogen atoms in the structure of a diamond. Diamond-like carbon can be given as a material containing hydrogen in its diamond-like structure, but many non-amorphous portions or double-bond portions contained in it prevent it from having both a low dielectric constant and high mechanical strength. As a result of investigation of the relationship between a dielectric constant and mechanical strength of various organic matters, the present inventors have found that a film in which a prominent peak appears at a Raman shift of from 690 to 800 cm⁻¹ in Raman spectroscopy has both a low dielectric constant and high mechanical strength.

The peak at a Raman shift of from 690 to 800 cm⁻¹ in an organic matter is usually attributable to a —C—C— bond and a high peak in this region indicates that chemical environments of the carbon atoms participating in the —C—C— bond are similar to some extent. They have found that a film containing many structures such as adamantane, diamantane and triamantane has a high peak and therefore such a film is preferred. It has already been revealed in SPECTROCHIMICA ACTA, 36A, 259 that structures such as adamantane, diamantane and triamantane have a peak at a Raman shift of from 690 to 800 cm⁻¹. The structure of them belongs to a cage structure which will be descried later. Such a structure is presumed to have high rigidity, because the chemical environments of the carbon atoms are similar to some extent and therefore, mechanical stress on them has been dispersed uniformly.

The peak near a Raman shift of 1600 cm⁻¹ in a compound containing carbon and hydrogen, on the other hand, is attributable to a structure having a —C═C— bond or a structure having an Sp² carbon such as aromatic structure. Incorporation of such a structure at a high content is not preferred because it gives heat resistance to the compound but increases a dielectric constant owing to high polarizability.

The peak intensity observed in Raman spectroscopy at from 1500 to 2000 cm⁻¹ (mainly, near 1600 cm⁻¹) attributable to a —C═C— bond or aromatic structure is preferably 0.7 time or less, more preferably 0.6 time or less, still more preferably 0.5 time or less, especially preferably 0.4 time or less, each as much as the above-described peak intensity at from 690 to 800 cm⁻¹ from the standpoint of the balance between heat resistance and dielectric constant.

According to NEWDIAMOND, 4(2), 16(1988, 4), the above-described diamond has a main peak at a Raman shift of 1333 cm⁻¹ and diamond-like carbon has a main peak at a Raman shift of 1550 cm⁻¹ so that they are excluded from the materials usable in the present invention.

The Raman spectroscopy in the invention can be carried out by a commercially available Raman spectrometer. Use of a micro Raman spectrometer is especially preferred. An excitation wavelength can be selected freely, but use of a wavelength in a near infrared region typified by YAG laser (wavelength: 1064 nm) is preferred because when it is used for analysis of an organic substance, it enables precise measurement with less noise.

A measuring method can be selected freely, but from the viewpoint of convenience and avoidance from the influence of an Si substrate, it is preferred to chip off a film of the film forming composition formed on the Si substrate or an insulating film after the crosslinking operation which will be described later and then, carry out Raman spectroscopy by a micro Raman spectrometer. For comparison of peak intensities, it is preferred to remove the background influence from the resulting Raman spectrum by using a commercially available soft ware. In the Raman spectroscopy in the invention, the peak intensity is defined by the intensity of a peak top from which background level is subtracted.

The film exhibiting the above-described properties in Raman spectroscopy can be formed, for example, by a film forming composition containing a compound having a cage structure which will be described later.

<Compound Having a Cage Structure>

The term “cage structure” as used herein means a molecule in which a plurality of rings formed of covalent-bonded atoms define the capacity of the structure and in which all points existing inside the capacity cannot leave the capacity without passing through the rings. For example, an adamantane structure may be considered as the cage structure. Contrary to this, a single crosslink-having cyclic structure such as norbornane (bicyclo[2,2,1]heptane) cannot be considered as the cage structure because the ring of the single-crosslinked cyclic compound does not define the capacity of the compound.

The cage structure of the invention may contain either a saturated bond or unsaturated bond and may contain a hetero atom such as oxygen, nitrogen or sulfur. A saturated hydrocarbon is however preferred from the viewpoint of a low dielectric constant.

Preferred examples of the cage structure of the invention include adamantane, biadamantane, diamantane, triamantane, tetramantane and dodecahedrane, of which adamantane and diamantane are more preferred. Of these, diamantane is especially preferred.

The cage structure according to the invention may have one or more substituents. Examples of the substituents include linear, branched or cyclic C₁₋₁₀ alkyl groups (such as methyl, t-butyl, cyclopentyl and cyclohexyl), C₂₋₁₀ alkenyl groups (such as vinyl and propenyl), C₂₋₁₀ alkynyl groups (such as ethynyl and phenylethynyl), C₆₋₂₀ aryl groups (such as phenyl, 1-naphthyl and 2-naphthyl), C₂₋₁₀ acyl groups (such as benzoyl), C₂₋₁₀ alkoxycarbonyl groups (such as methoxycarbonyl), C₁₋₁₀ carbamoyl groups (such as N,N-diethylcarbamoyl), C₆₋₂₀ aryloxy groups (such as phenoxy), C₆₋₂₀ arylsulfonyl groups (such as phenylsulfonyl), nitro group, cyano group, and silyl groups (such as triethoxysilyl, methyldiethoxysilyl and trivinylsilyl).

In the invention, the cage structure has preferably a valence of from two to four. In this case, a group to be bound to the cage structure may be a substituent having a valence of one or more or a linking group having a valence of two or more. The cage structure has more preferably a valence of two or three, especially a valence of two. The term “valence” as used herein means the number of chemical bonds.

The “compound having a cage structure” of the invention is preferably a polymer available from a monomer having a cage structure. The term “monomer” as used herein means a molecule which will be polymerized into a dimer or higher polymer. The polymer may be either a homopolymer or copolymer.

The polymerization reaction of the monomer starts by a polymerizable group substituted for the monomer. The term “polymerizable group” as used herein means a reactive substituent which polymerizes the monomer. Although the polymerization reaction is not limited, examples include radical polymerization, cationic polymerization, anionic polymerization, ring-opening polymerization, polycondensation, polyaddition, addition condensation and polymerization using a transition metal catalyst.

The polymerization reaction of the monomer in the invention is preferably carried out in the presence of a non-metallic polymerization initiator. For example, a monomer having a polymerizable carbon-carbon double bond or carbon-carbon triple bond can be polymerized in the presence of a polymerization initiator showing activity while generating free radicals such as carbon radicals or oxygen radicals by heating.

The polymerization initiator usable in the invention preferably shows activity while generating free radicals such as carbon radicals or oxygen radicals by heating. Organic peroxides or organic azo compounds are especially preferred.

Preferred examples of the organic peroxides include ketone peroxides such as “PERHEXA H”, peroxyketals such as “PERHEXA TMH”, hydroperoxides such as “PERBUTYL H-69”, dialkylperoxides such as “PERCUMYL D”, “PERBUTYL C” and “PERBUTYL D”, diacyl peroxides such as “NYPER BW”, peroxy esters such as “PERBUTYL Z” and “PERBUTYL L”, and peroxy dicarbonates such as “PEROYL TCP”, (each, trade name; commercially available from NOF Corporation), diisobutyryl peroxide, cumylperoxyneodecanoate, di-n-propylperoxydicarbonate, diisopropylperoxydicarbonate, di-sec-butylperoxydicarbonate, 1,1,3,3-tetramethylbutylperoxyneodecanoate, di(4-t-butylchlorohexyl)peroxydicarbonate, di(2-ethylhexyl)peroxydicarbonate, t-hexylperoxyneodecanoate, t-butylperoxyneodecanoate, t-butylperoxyneoheptanoate, t-hexylperoxypivalate, t-butylperoxypivalate, di(3,5,5-trimethyl hexanoyl)peroxide, dilauroyl peroxide, 1,1,3,3-tetramethylbutylperoxy-2-ethylhexanoate, disuccinic acid peroxide, 2,5-dimethyl-2,5-di(2-ethylhexanoylperoxy)hexane, t-hexylperoxy-2-ethylhexanoate, di(4-methyl benzoyl)peroxide, t-butylperoxy-2-ethylhexanoate, di(3-methylbenzoyl)peroxide, benzoyl(3-methylbenzoyl)peroxide, dibenzoyl peroxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1-di(t-butylperoxy)cyclohexane, 2,2-di(4,4-di-(t-butylperoxy)cyclohexyl)propane, t-hexylperoxyisopropyl monocarbonate, t-butylperoxymaleic acid, t-butylperoxy-3,5,5-trimethylhexanoate, t-butyolperoxylaurate, t-butylperoxyisopropylmonocarbonate, t-butylperoxy-2-ethylhexylmonocarbonate, t-hexylperoxybenzoate, 2,5-dimethyl-2,5-di(benzoylperoxy)hexane, t-butylperoxyacetate, 2,2-di-(t-butylperoxy)butane, t-butylperoxybenzoate, n-butyl-4,4-di-t-butylperoxyvalerate, di(2-t-butylperoxyisopropyl)benzene, dicumyl peroxide, di-t-hexyl peroxide, 2,5-dimethyl-2,5-di(t-butylperoxy)hexane, t-butylcumyl peroxide, di-t-butyl peroxide, p-methane hydroperoxide, 2,5-dimethyl-2,5-di(t-butylperoxy)hexine-3, diisopropylbenzene hydroperoxide, 1,1,3,3-tetramethylbutyl hydroperoxide, cumene hydroperoxide, t-butyl hydroperoxide, 2,3-dimethyl-2,3-diphenylbutane, 2,4-dichlorobenzoyl peroxide, o-chlorobenzoyl peroxide, p-chlorobenzoyl peroxide, tris-(t-butylperoxy)triazine, 2,4,4-trimethylpentylperoxyneodecanoate, α-cumylperoxyneodecanoate, t-amylperoxy-2-ethylhexanoate, t-butylperoxyisobutyrate, di-t-butylperoxyhexahydroterephthalate, di-t-butylperoxytrimethyladipate, di-3-methoxybutylperoxydicarbonate, di-isopropylperoxydicarbonate, t-butylperoxyisopropylcarbonate, 1,6-bis(t-butylperoxycarbonyloxy)hexane, diethylene glycol bis(t-butylperoxycarbonate) and t-hexylperoxyneodecanoate.

Examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, and azoamidine compounds such as “V-50” and VA-057” (each, trade name; commercially available from Wako Pure Chemical Industries), 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutyronitrile), 1,1-azobis(cyclohexane-1-carbonitrile), 1-[(1-cyano-1-methylethyl)azo]formamide, 2,2-azobis{2-methyl-N-[1,1-bis(hydroxymethyl)-2-hydroxyethyl]propionamide}, 2,2-azobis[2-methyl-N-(2-hydroxybutyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazolin-2-yl)propane]dihydrochloride, 2,2-azobis[2-(2-imidazolin-2-yl)]propane]disulfate dihydrate, 2,2-azobis{2-[1-(2-hydroxyethyl)-2-imidazolin-2-yl]propane}dihydrochloride, 2,2-azobis[2-[2-imidazolin-2-yl]propane], 2,2-azobis(1-imino-1-pyrrolidino-2-methylpropane)dihydrochloride, 2,2-azobis(2-methylpropionamidine)dihydrochloride, 2,2-azobis[N-(2-carboxyethyl)-2-methylpropionamidine]tetrahydrate, dimethyl-2,2-azobis(2-methylpropionate), 4,4-azobis(4-cyanovaleric acid) and 2,2-azobis(2,4,4-trimethylpentane).

In the invention, these polymerization initiators may be used either singly or in combination.

The amount of the polymerization initiator in the invention is preferably from 0.001 to 2 moles, more preferably from 0.01 to 1 mole, especially preferably from 0.05 to 0.5 mole, per mole of the monomer.

In the invention, the polymerization reaction of a monomer may be effected in the presence of a transition metal catalyst. For example, it is preferred to carry out polymerization of a monomer having a polymerizable carbon-carbon double bond or carbon-carbon triple bond, for example, in the presence of a Pd catalyst such as Pd(PPh₃)₄ or Pd(OAc)₂, a Ziegler-Natta catalyst, an Ni catalyst such as nickel acetyl acetonate, a W catalyst such as WCl₆, an Mo catalyst such as MoCl₅, a Ta catalyst such as TaCl₅, an Nb catalyst such as NbCl₅, an Rh catalyst or a Pt catalyst.

In the invention, these transition metal catalysts may be used either singly or in combination.

In the invention, the amount of the transition metal catalyst is preferably from 0.001 to 2 moles, more preferably from 0.01 to 1 mole, especially preferably from 0.05 to 0.5 mole per mole of the monomer.

The cage structure in the invention may be substituted as a pendant group in the polymer or may become a portion of the polymer main chain, but latter is preferred. When the cage structure becomes a portion of the polymer main chain, the polymer chain is broken by the removal of the cage compound from the polymer. In this state, the cage structure may be linked directly via a single bond or by an appropriate divalent linking group. Example of the linking group include —C(R₁₁)(R₁₂)—, —C(R₁₃)═C(R₁₄)—, —C≡C—, arylene group, —CO—, —O—, —SO₂—, —N(R₁₅)—, and —Si(R₁₆)(R₁₇)—, and combination thereof. In these groups, R₁₁ to R₁₇ each independently represents a hydrogen atom, an alkyl group, an alkenyl group, an alkynyl group or an aryl group. These linking groups may be substituted by a substituent and as the substituent, the above-described ones are preferred.

Of these, —C(R₁₁)(R₁₂)—, —CH═CH—, —C≡C—, arylene group, —O—, —Si(R₁₆)(R₁₇)— and combination thereof are more preferred, with —C(R₁₁)(R₁₂)— and —CH═CH— being especially preferred in consideration of a low dielectric constant.

The compound of the invention having a cage structure may be either a low molecular compound or high molecular compound (for example, polymer), but is preferably a polymer. When the compound having a cage structure is a polymer, its mass average molecular weight is preferably from 1000 to 500000, more preferably from 5000 to 200000, especially preferably from 10000 to 100000. The polymer having a cage structure may be contained, as a resin composition having a molecular weight distribution, in a coating solution for forming an insulating film. When the compound having a cage structure is a low molecular compound, its molecular weight is preferably from 150 to 3000, more preferably from 200 to 2000, especially preferably from 220 to 1000.

The compound of the invention having a cage structure is preferably be a polymer of a monomer having a polymerizable carbon-carbon double bond or carbon-carbon triple bond, more preferably a polymer of a compound represented by the following formulas (I) to (VI).

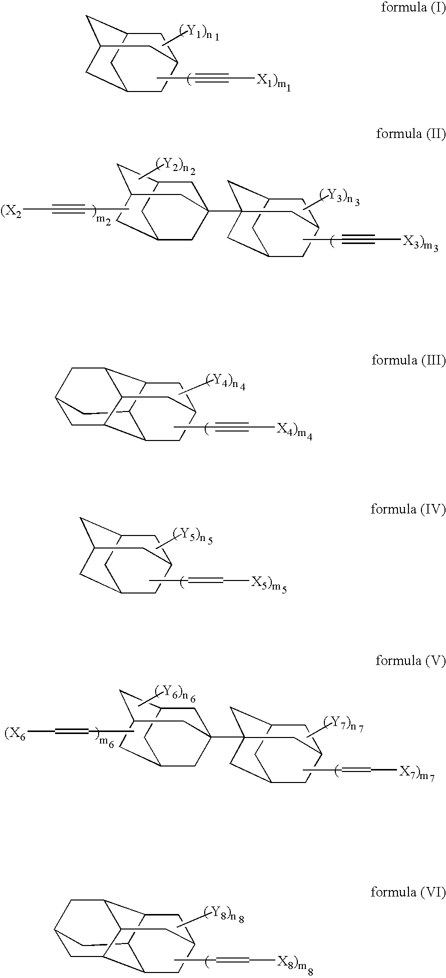

In the formulas (I) to (VI),

X₁ to X₈ each independently represents a hydrogen atom, an alkyl group (preferably C₁₋₁₀), alkenyl group (preferably C₂₋₁₀), alkynyl group (preferably C₂₋₁₀), aryl group (preferably C₆₋₂₀), silyl group (preferably C₀₋₂₀), acyl group (preferably C₂₋₁₀), alkoxycarbonyl group (preferably C₂₋₁₀), or carbamoyl group (preferably C₁₋₂₀), of which hydrogen atom, C₁₋₁₀ alkyl group, C₆₋₂₀ aryl group, C₀₋₂₀ silyl group, C₂₋₁₀ acyl group, C₂₋₁₀ alkoxycarbonyl group, or C₁₋₂₀ carbamoyl group is preferred; hydrogen atom or C₆₋₂₀ aryl group is more preferred; and hydrogen atom is especially preferred.

Y₁ to Y₈ each independently represents an alkyl group (preferably C₁₋₁₀), aryl group (preferably C₆₋₂₀), or silyl group (preferably C₀₋₂₀), of which substituted or unsubstituted C₁₋₁₀ alkyl or C₆₋₂₀ aryl group is more preferred and an alkyl group (such as methyl) is especially preferred.

X₁ to X₈ and Y₁ to Y₈ each may be substituted by other substituent group.

In the above-described formulas,

m₁ and m₅ each independently represents an integer of from 1 to 16, preferably from 1 to 4, more preferably from 1 to 3, especially preferably 2;

n₁ and n₅ each independently represents an integer of from 0 to 15, preferably from 0 to 4, more preferably 0 or 1, especially preferably 0;

m₂, m₃, m₆ and m₇ each independently represents an integer of from 1 to 15, preferably from 1 to 4, more preferably from 1 to 3, especially preferably 2;

n₂, n₃, n₆ and n₇ each independently represents an integer of from 0 to 14, preferably from 0 to 4, more preferably 0 or 1, especially preferably 0,

m₄ and m₈ each independently represents an integer of from 1 to 20, preferably from 1 to 4, more preferably from 1 to 3, especially preferably 2; and

n₄ and n₈ each independently represents an integer of from 0 to 19, preferably from 0 to 4, more preferably 0 or 1, especially preferably 0.

The monomer of the invention having a cage structure is preferably a compound represented by the above-described formula (II), (III), (V) or (VI), more preferably a compound represented by the formula (II) or (III), especially preferably a compound represented by the formula (III).

Two or more of these compounds of the invention having a cage structure may be used in combination, or two or more of these monomers of the invention having a cage structure may be copolymerized.

The compounds of the invention having a cage structure preferably have sufficient solubility in an organic solvent. The solubility at 25° C. in cyclohexanone or anisole is preferably 3 mass % or greater, more preferably at 5 mass % or greater, especially preferably 10 mass % or greater.

Examples of the compound of the invention having a cage structure include polybenzoxazoles as described in JP-A-11-322929 (the term “JP-A” as used herein means an unexamined published Japanese patent application), JP-A-2003-12802, and JP-A-2004-18593, quinoline resins as described in JP-A-2001-2899, polyaryl resins as described in JP-T-2003-530464 (the term “JP-T” as used herein means a published Japanese translation of a PCT patent application), JP-T-2004-535497, JP-T-2004-504424, JP-T-2004-504455, JP-T-2005-501131, JP-T-2005-516382, JP-T-2005-514479, JP-T-2005-522528, JP-A-2000-100808 and U.S. Pat. No. 6,509,415, polyadamantanes as described in JP-A-11-214382, JP-A-2001-332542, JP-A-2003-252982, JP-A-2003-292878, JP-A-2004-2787, JP-A-2004-67877 and JP-A-2004-59444, and polyimides as described in JP-A-2003-252992 and JP-A-2004-26850.

Specific examples of the monomer having a cage structure and usable in the invention will next be shown, but the present invention is not limited thereto.

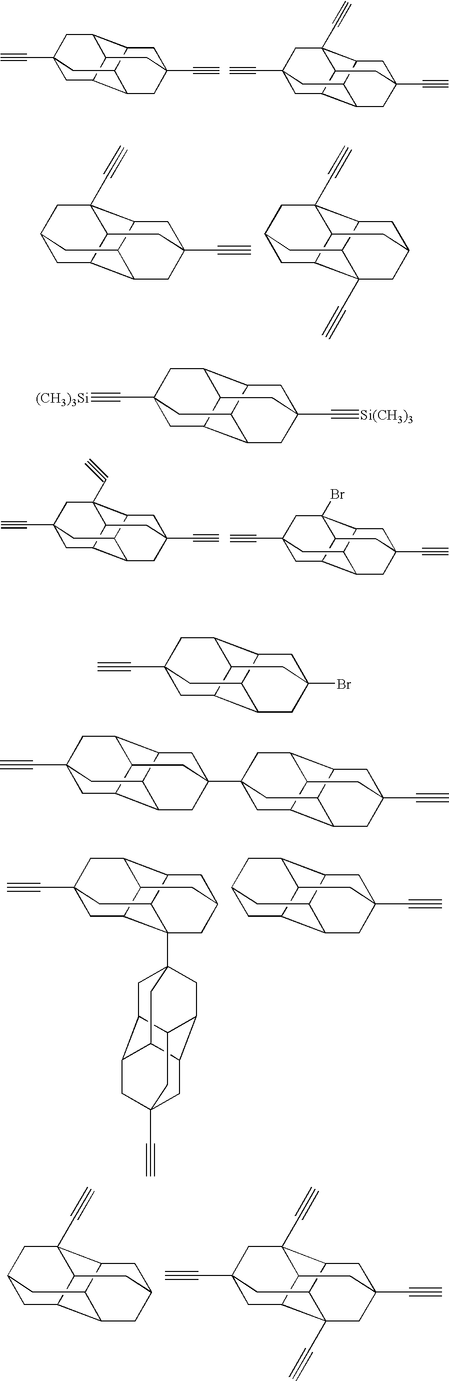

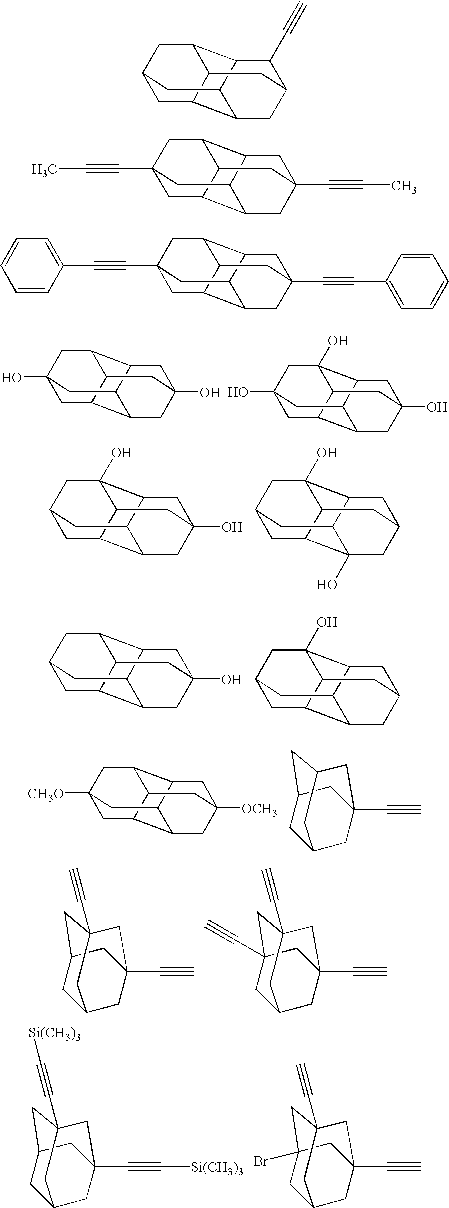

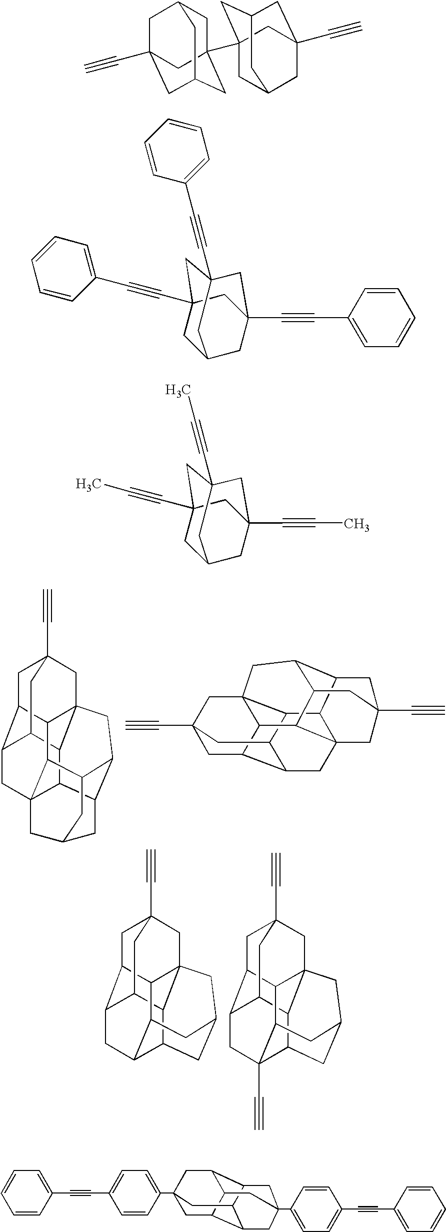

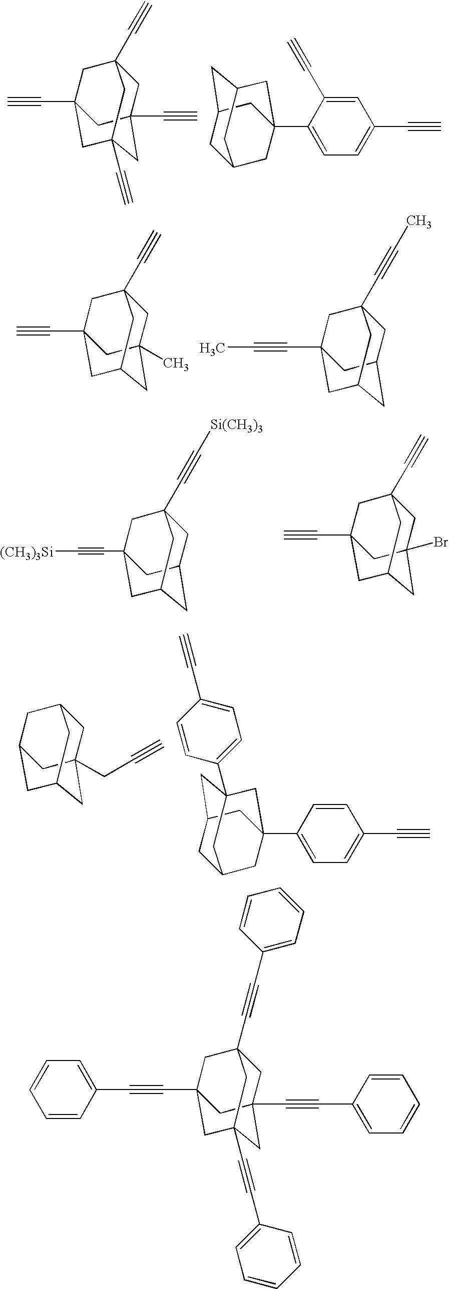

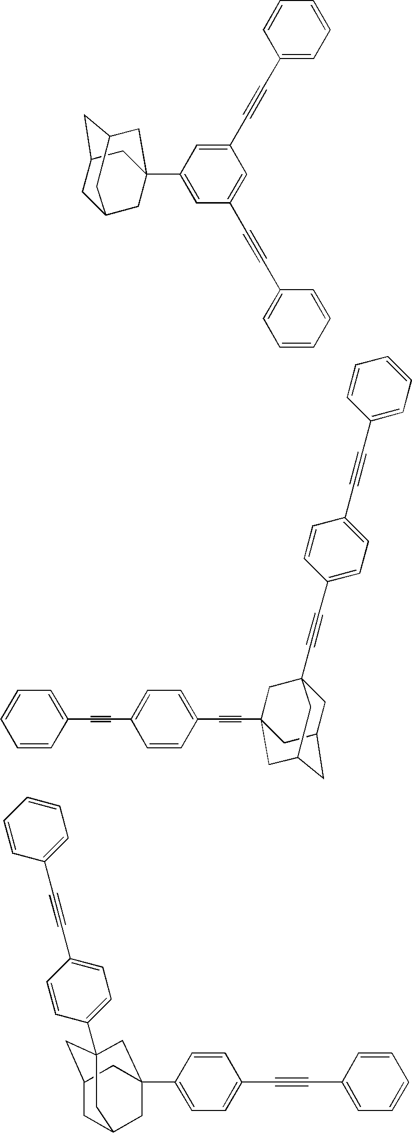

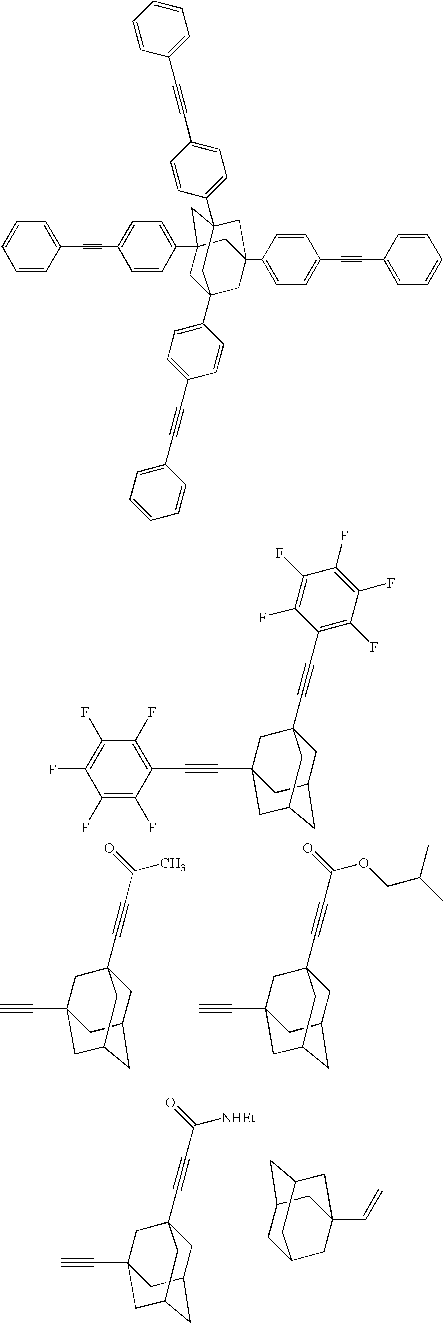

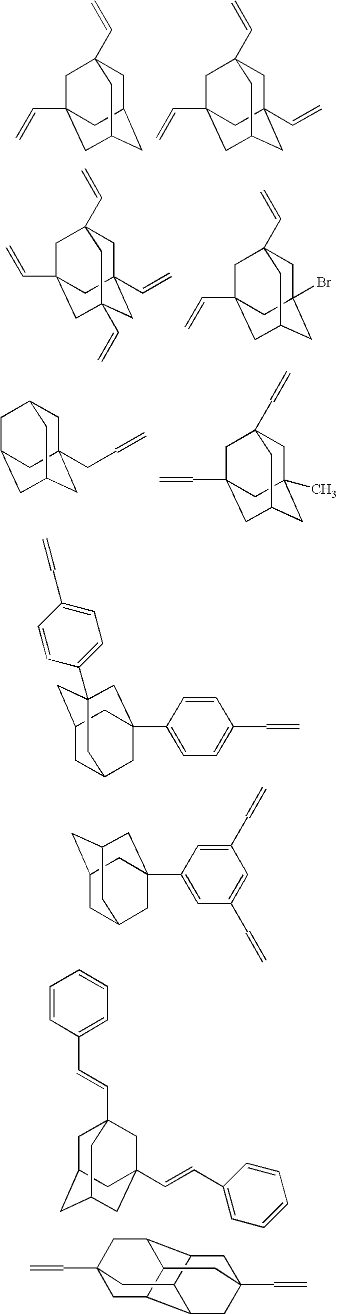

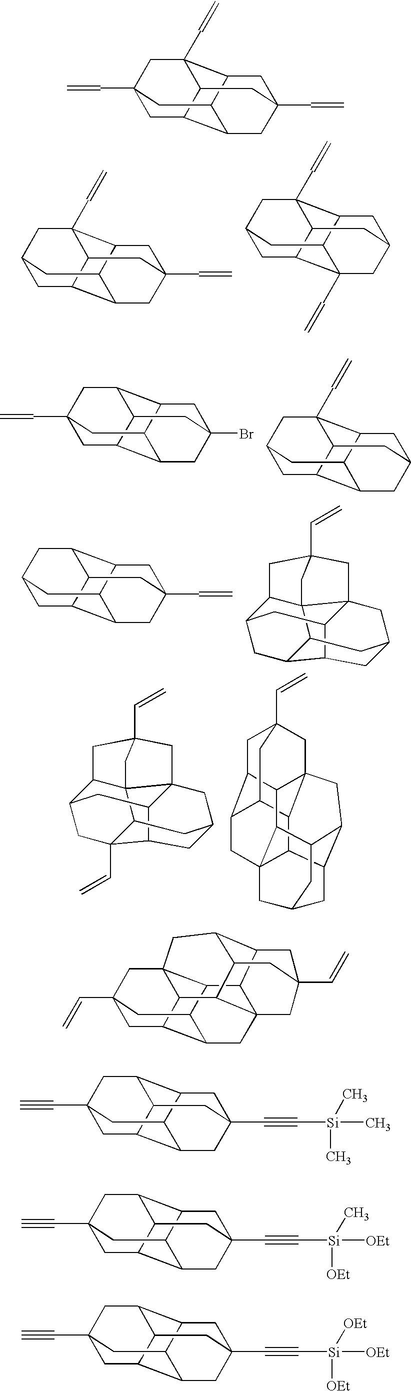

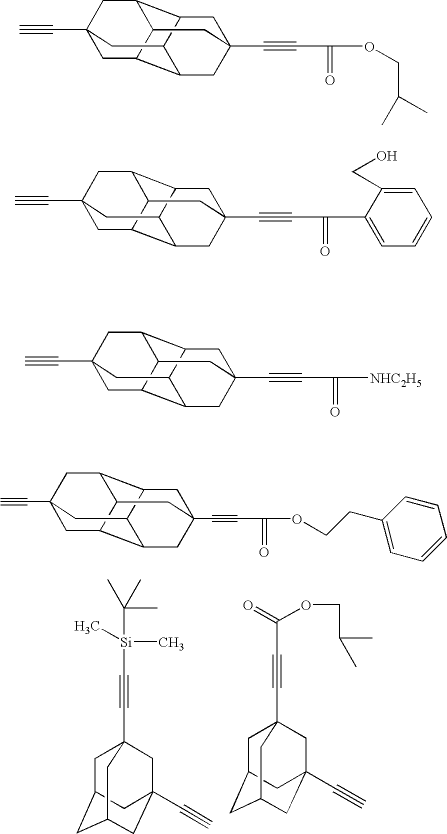

As the solvent to be used for polymerization reaction, any solvent capable of dissolving therein a raw material monomer having a necessary concentration and having no adverse effects on the properties of a film formed from the resulting polymer can be used. Examples include water; alcohol solvents such as methanol, ethanol and propanol; ketone solvents such as alcohol acetone, methyl ethyl ketone, methyl isobutyl ketone, cyclohexanone and acetophenone; ester solvents such as ethyl acetate, butyl acetate, propylene glycol monomethyl ether acetate, γ-butyrolactone, and methyl benzoate; ether solvents such as dibutyl ether and anisole; aromatic hydrocarbon solvents such as toluene, xylene, mesitylene and 1,3,5-triisopropylbenzene; amide solvents such as N-methylpyrrolidinone and dimethylacetamide; and aliphatic hydrocarbon solvents such as hexane, heptane, octane and cyclohexane. Of these, more preferred are acetone, methyl ethyl ketone, methyl isobutyl ketone, cyclohexanone, acetophenone, ethyl acetate, propylene glycol monomethyl ether acetate, γ-butyrolactone, anisole, tetrahydrofuran, toluene, xylene, mesitylene, 1,3,5-triisopropylbenzene, and t-butylbenzene, of which tetrahydrofuran, γ-butyrolactone, anisole, toluene, xylene, mesitylene, 1,3,5-triisopropylbenzene, and t-butylbenzene, with γ-butyrolactone, anisole, mesitylene, 1,3,5-triisopropylbenzene, and t-butylbenzene being especially preferred. These solvents may be used either singly or in combination.

The concentration of the monomer in the reaction mixture is preferably from 1 to 50 mass %, more preferably from 5 to 30 mass %, especially preferably from 10 to 20 mass %.

The optimum conditions for the polymerization reaction in the invention differ, depending on the kind or concentration of the polymerization initiator, monomer or solvent. The internal temperature is preferably from 0 to 200° C., more preferably from 50 to 170° C., especially preferably from 100 to 150° C., while the reaction time is preferably from 1 to 50 hours, more preferably from 2 to 20 hours, especially preferably from 3 to 10 hours.

In order to suppress the inactivation of the polymerization initiator due to oxygen, the reaction is performed preferably in an inert gas atmosphere (such as nitrogen or argon). The oxygen concentration during the reaction is preferably 100 ppm or less, more preferably 50 ppm or less, especially preferably 20 ppm or less.

The monomer of the invention having a cage structure can be synthesized by using, for example, commercially available diamantane as a raw material, reacting it with bromine in the presence or absence of an aluminum bromide catalyst to introduce a bromine atom into a desired position, causing Friedel-Crafts reaction between the resulting compound with vinyl bromine in the presence of a Lewis acid such as aluminum bromide, aluminum chloride or iron chloride to introduce a 2,2-dibromoethyl group, and then converting it into ethynyl group by the HBr elimination using a strong base. More specifically, it can be synthesized in accordance with the process as described in Macromolecules, 24, 5266-5268(1991) and 28, 5554-5560(1995), Journal of Organic Chemistry, 39, 2995-3003(1974) and the like.

An alkyl group or silyl group may be introduced by making the hydrogen atom of the terminal acetylene group anionic by butyl lithium or the like and then reacting the resulting compound with an alkyl halide or silyl halide.

It is preferred that the solubility of the polymer of the invention in cyclohexanone or anisole at 25° C. is 3 wt. % or greater.

In order to prevent precipitation of insoluble matters with the passage of time during storage of the coating solution, the polymer has preferably a higher solubility. The solubility of the polymer of the invention in cyclohexanone or anisole at 25° C. is more preferably 7 mass % or greater, especially preferably 10 mass % or greater.

The polymer of the invention may be used alone or two or more of the polymers may be used in combination.

The film forming composition of the invention contains a coating solvent so that it can be provided as a coating solution suited for film formation.

Although no particular limitation is imposed on the coating solvent to be used in the invention, examples include organic solvents, e.g., alcohol solvents such as methanol, ethanol, 2-propanol, 1-butanol, 2-ethoxymethanol, 3-methoxypropanol and 1-methoxy-2-propanol; ketone solvents such as acetone, acetylacetone, methyl ethyl ketone, methyl isobutyl ketone, 2-pentanone, 3-pentanone, 2-heptanone, 3-heptanone, cyclopentanone and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether solvents such as diisopropyl ether, dibutyl ether, ethyl propyl ether, anisole, phenetole and veratrol; aromatic hydrocarbon solvents such as mesitylene, ethylbenzene, diethylbenzene, propylbenzene and t-butylbenzene; and amide solvents such as N-methylpyrrolidinone and dimethylacetamide. These solvents may be used either singly or in combination.

Of these, more preferred are 1-methoxy-2-propanol, propanol, acetylacetone, cyclohexanone, propylene glycol monomethyl ether acetate, butyl acetate, methyl lactate, ethyl lactate, γ-butyrolactone, anisole, mesitylene, and t-butylbenzene, with 1-methoxy-2-propanol, cyclohexanone, propylene glycol monomethyl ether acetate, ethyl lactate, γ-butyrolactone, t-butylbenzene and anisole being especially preferred.

The solid concentration of the film forming composition of the invention is preferably from 1 to 50 mass %, more preferably from 2 to 15 mass %, especially preferably from 3 to 10 mass %.

The content of metals, as an impurity, of the film forming composition of the invention is preferably as small as possible. The metal content of the film forming composition can be measured with high sensitivity by the ICP-MS and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process decreases the dielectric constant of the film obtained by the invention. Its content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis.

When W ray is employed as an X-ray source, K, Ca, Ti, Cr, Mn, Fe, Co, Ni, Cu, Zn, and Pd can be measured as metal elements. The concentrations of them are each preferably from 100×10¹⁰ atom·cm⁻² or less, more preferably 50×10¹⁰ atom·cm⁻² or less, especially preferably 10×10¹⁰ atom·cm⁻² or less.

In addition, the concentration of Br as a halogen can be measured. Its remaining amount is preferably 10000×10¹⁰ atom·cm⁻² or less, more preferably 1000×10¹⁰ atom·cm⁻², especially preferably 400×10¹⁰ atom cm⁻².

Moreover, the concentration of Cl can also be observed as a halogen. In order to prevent it from damaging a CVD device, etching device or the like, its remaining amount is preferably 100×10¹⁰ atom·cm⁻² or less, more preferably 50×10¹⁰ atom·cm⁻², especially preferably 10×10¹⁰ atom·cm⁻².

To the film forming composition of the invention, additives such as radical generator, colloidal silica, surfactant, silane coupling agent and adhesive agent may be added without impairing the properties (such as heat resistance, dielectric constant, mechanical strength, coatability, and adhesion) of the insulating film obtained using it.

Any colloidal silica may be used in the invention. For example, a dispersion obtained by dispersing high-purity silicic anhydride in a hydrophilic organic solvent or water and having usually an average particle size of from 5 to 30 nm, preferably from 10 to 20 nm and a solid concentration of from about 5 to 40 mass % can be used.

Any surfactant may be added in the invention. Examples include nonionic surfactants, anionic surfactants and cationic surfactants. Further examples include silicone surfactants, fluorosurfactants, polyalkylene oxide surfactants, and acrylic surfactants. In the invention, these surfactants can be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably from 0.01 mass % or greater but not greater than 1 mass %, more preferably from 0.1 mass % or greater but not greater than 0.5 mass % based on the total amount of the film forming coating solution.

The term “silicone surfactant” as used herein means a surfactant containing at least one Si atom. Any silicone surfactant may be used in the invention, but it preferably contains a structure containing an alkylene oxide and dimethylsiloxane, of which a silicone surfactant containing a compound represented by the following chemical formula is more preferred:

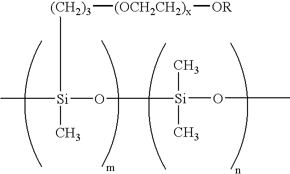

In the above formula, R represents a hydrogen atom or an alkyl group (preferably, C₁₋₅), x stands for an integer of from 1 to 20, and m and n each independently represents an integer of from 2 to 100. When a plurality of xs and Rs exist, they may be the same or different.

Examples of the silicone surfactant to be used in the invention include “BYK 306”, “BYK 307” (each, trade name; product of BYK Chemie), “SH7PA”, “SH21PA”, “SH28PA”, and “SH30PA” (each, trade name; product of Dow Corning Toray Silicone) and Troysol S366 (trade name; product of Troy Chemical).

As the nonionic surfactant to be used in the invention, any nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any fluorosurfactant is usable. Examples include perfluorooctyl polyethylene oxide, perfluorodecyl polyethylene oxide and perfluorododecyl polyethylene oxide.

As the acrylic surfactant to be used in the invention, any acrylic surfactant is usable. Examples include (meth)acrylic acid copolymer.

Any silane coupling agent may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. Those silane coupling agents may be used either singly or in combination.

In the invention, any adhesion accelerator may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate disopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-methacryloxypropyltrimethoxysialne, 3-mercaptopropyltrimethoxysilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion accelerator.

The amount of the adhesion accelerator is preferably 10 parts by mass or less, especially preferably from 0.05 to 5 parts by mass, based on 100 parts by mass of the total solid content.

It is also possible to form a porous film by adding a pore forming factor to the extent permitted by the mechanical strength of the film and thereby reducing the dielectric constant of the film.

Although no particular limitation is imposed on the pore forming factor as an additive to serve as a pore forming agent, a non-metallic compound is preferred. The pore forming agent must satisfy both the solubility in a solvent to be used for a film forming coating solution and compatibility with the polymer of the invention. The boiling point or decomposition point of the pore forming agent is preferably from 100 to 500° C., more preferably from 200 to 450° C., especially preferably from 250 to 400° C. The molecular weight of it is preferably from 200 to 50000, more preferably from 300 to 10000, especially preferably from 400 to 5000. The amount in terms of mass % is preferably from 0.5 to 75%, more preferably from 0.5 to 30%, especially preferably from 1 to 20% relative to the polymer for forming a film. The polymer may contain a decomposable group as the pore forming factor. The decomposition point of it is preferably from 100 to 500° C., more preferably from 200 to 450° C., especially preferably from 250 to 400° C. The content of the decomposable group is, in terms of mole %, from 0.5 to 75%, more preferably from 0.5 to 30 mole %, especially preferably from 1 to 20% relative to the polymer for forming the film.

Examples of the polymer usable as a pore forming agent include aromatic polyvinyl compounds (such as polystyrene, polyvinylpyridine and aromatic halogenated polyvinyl compound), polyacrylonitrile, polyalkylene oxides (such as polyethylene oxide and polypropylene oxide), polyethylene, polylactic acid, polysiloxane, polycaprolactone, polycaprolactam, polyurethane, polymethacrylates (such as polymethyl methacrylate), polymethacrylic acid, polyacrylates (such as polymethyl acrylate), polyacrylic acid, polydienes (such as polybutadiene and polyisoprene), polyvinyl chloride, polyacetals and amine-capped alkylene oxides.

Moreover, polyphenylene oxide, poly(dimethylsiloxane), polytetrahydrofuran, polycyclohexylethylene, polyethyloxazoline, polyvinylpyridine and polycaprolactone are also usable.

Polystyrene is especially preferred as the pore forming agent. Examples of the polystyrene include anionic polymerized polystyrene, syndiotactic polystyrene, unsubstituted or substituted polystyrene (such as poly(α-methylstyrene)). Of these, unsubstituted polystyrene is preferred.

Examples of the thermoplastic pore-forming polymer include polyacrylate, polymethacrylate, polybutadiene, polyisoprene, polyphenylene oxide, polypropylene oxide, polyethylene oxide, poly(dimethylsiloxane), polytetrahydrofuran, polyethylene polycyclohexylethylene, polyethyloxazoline, polycaprolactone, polylactic acid and polyvinylpyridine.

The film can be formed by applying the film forming composition of the invention onto a substrate by a desired method such as spin coating, roller coating, dip coating or scan coating, and then heating to remove the solvent and dry the film. As the method of applying the composition to the substrate, spin coating and scan coating are preferred, with spin coating being especially preferred. For spin coating, commercially available apparatuses such as “Clean Track Series” (trade name; product of Tokyo Electron), “D-spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate.

When the solution of the composition is discharged, either dynamic discharge in which the solution is discharged onto a rotating substrate or static discharge in which the solution is discharged onto a static substrate may be employed. The dynamic discharge is however preferred in view of the in-plane uniformity of the film. Alternatively, from the viewpoint of reducing the consumption amount of the composition, a method of discharging only a main solvent of the composition to a substrate in advance to form a liquid film and then discharging the composition thereon can be employed. Although no particular limitation is imposed on the spin coating time, it is preferably within 180 seconds from the viewpoint of throughput. From the viewpoint of the transport of the substrate, it is preferred to subject the substrate to processing (such as edge rinse or back rinse) for preventing the film from remaining at the edge portion of the substrate. The heat treatment method is not particularly limited, but ordinarily employed methods such as hot plate heating, heating with a furnace, heating in an RTP (Rapid Thermal Processor) to expose the substrate to light of, for example, a xenon lamp can be employed. Of these, hot plate heating or heating with a furnace is preferred. As the hot plate, a commercially available one, for example, “Clean Track Series” (trade name; product of Tokyo Electron), “D-spin Series” (trade name; product of Dainippon Screen) and “SS series” or “CS series” (trade name; product of Tokyo Oka Kogyo) is preferred, while as the furnace, “a series” (trade name; product of Tokyo Electron) is preferred.

It is especially preferred to apply the polymer of the invention onto a substrate and then cure (bake) it by heating. For this purpose, the polymerization reaction of a carbon triple bond remaining in the polymer at the time of post heating may be utilized. The post heat treatment is performed preferably at from 100 to 450° C., more preferably at from 200 to 420° C., especially preferably at from 350 to 400° C., preferably for from 1 minute to 2 hours, more preferably for from 10 minutes to 1.5 hours, especially preferably for from 30 minutes to 1 hour. The post heat treatment may be performed in several times. This post heat treatment is performed especially preferably in a nitrogen atmosphere in order to prevent thermal oxidation due to oxygen.

In the invention, the polymer may be cured (baked) not by heat treatment but by exposure to high energy radiation to cause polymerization reaction of a carbon triple bond remaining in the polymer. Examples of the high energy radiation include electron beam, ultraviolet ray and X ray. The curing (baking) method is not particularly limited to these methods.

When electron beam is employed as high energy radiation, the energy is preferably 50 keV or less, more preferably 30 keV or less, especially preferably 20 keV or less. Total dose of electron beam is preferably 5 μC/cm² or less, more preferably 2 μC/cm² or less, especially preferably 1 μC/cm² or less. The substrate temperature when it is exposed to electron beam is preferably from 0 to 450° C., more preferably from 0 to 400° C., especially preferably from 0 to 350° C. Pressure is preferably from 0 to 133 kPa, more preferably from 0 to 60 kPa, especially preferably from 0 to 20 kPa. The atmosphere around the substrate is preferably an atmosphere of an inert gas such as Ar, He or nitrogen from the viewpoint of preventing oxidation of the polymer of the invention. An oxygen, hydrocarbon or ammonia gas may be added for the purpose of causing reaction with plasma, electromagnetic wave or chemical species which is generated by the interaction with electron beam. In the invention, exposure to electron beam may be carried out in plural times. In this case, the exposure to electron beam is not necessarily carried out under the same conditions but the conditions may be changed every time.

Ultraviolet ray may be employed as high energy radiation. The radiation wavelength range of the ultraviolet ray is preferably from 190 to 400 nm, while its output immediately above the substrate is preferably from 0.1 to 2000 mWcm₋₂. The substrate temperature upon exposure to ultraviolet ray is preferably from 250 to 450° C., more preferably from 250 to 400° C., especially preferably from 250 to 350° C. The atmosphere around the substrate is preferably an atmosphere of an inert gas such as Ar, He or nitrogen from the viewpoint of preventing oxidation of the polymer of the invention. The pressure at this time is preferably from 0 to 133 kPa.

When the film obtained using the film forming composition of the invention is used as an interlayer insulating film for semiconductor, a barrier layer for preventing metal migration may be disposed on the side of an interconnect. In addition, a cap layer, an interlayer adhesion layer or etching stopping layer may be disposed on the upper or bottom surface of the interconnect or interlayer insulating film to prevent exfoliation at the time of CMP (Chemical Mechanical Polishing). Moreover, an interlayer insulating film made of another material may be disposed as needed to form plural layers.

The film obtained using the film forming composition of the invention can be etched for copper interconnection or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, the ashing residue may be removed by washing.

The film obtained using the film forming composition of the invention may be subjected to CMP for planarizing the copper plated portion after copper interconnection. As a CMP slurry (chemical solution), a commercially available one (for example, product of Fujimi Incorporated, Rodel Nitta, JSR or Hitachi Chemical) can be used as needed. As a CMP apparatus, a commercially available one (for example, product of Applied Material or Ebara Corporation) can be used as needed. After CMP, the film can be washed in order to remove the slurry residue.

The film available using the film forming composition of the invention can be used for various purposes. For example, it is suited as an insulating film for semiconductor devices such as LSI, system LSI, DRAM, SDRAM, RDRAM, and D-RDRAM, and for electronic parts such as multi-chip module multilayered wiring boards. More specifically, it is usable as an interlayer insulating film for semiconductor, etching stopper film, surface protective film, and buffer coat film and in addition, as a passivation film in LSI, α-ray blocking film, cover lay film in flexographic plates, overcoat film, cover coat for flexible copper-lined plates, solder-resist film, and liquid-crystal alignment film.

As another purpose, the film of the invention can be used as a conductive film after doping thereinto an electron donor or acceptor, thereby imparting it with conductivity.

### EXAMPLES

The present invention will next be described by the following Examples, but the scope of it is not limited by them.

### Example 1

In accordance with the synthesis process as described in Macromolecules, 24, 5266-5268(1991), 4,9-diethynyldiamantane was synthesized. Under a nitrogen gas stream, 2 g of 4,9-diethynyldiamantane, 0.22 g of dicumyl peroxide (“PERCUMYL D”, trade name; product of NOF) and 10 ml of t-butylbenzene were polymerized by stirring them for 7 hours at an internal temperature of 150° C. After the reaction mixture was cooled to room temperature, 60 ml of isopropyl alcohol was added. The solid thus precipitated was collected by filtration and washed with isopropyl alcohol, whereby 0.8 g of polymer (A) having a mass-average molecular weight of about 15000 was obtained.

The solubility of Polymer (A) in cyclohexanone was 15 mass % or greater at 25° C.

A coating solution was prepared by completely dissolving 1.0 g of Polymer (A) in 10 g of cyclohexanone. The resulting solution was filtered through a 0.1 μm filter made of tetrafluoroethylene, followed by spin coating on a silicon wafer, whereby a film was obtained.

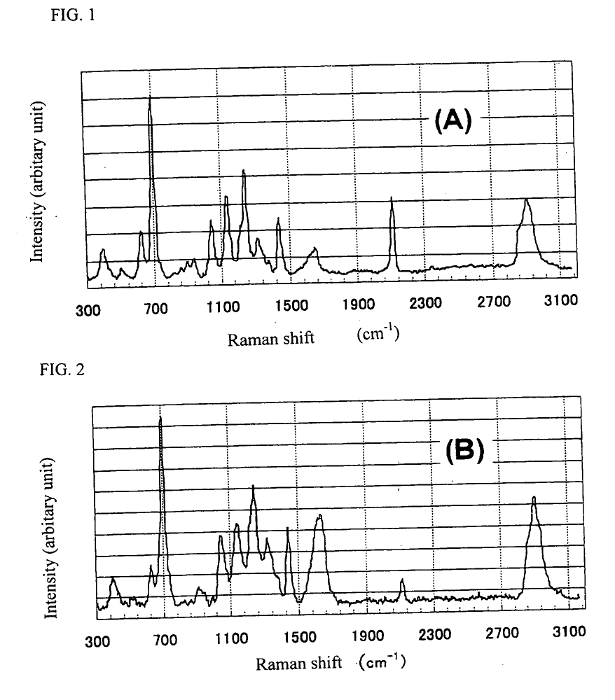

A portion of the film was chipped off and subjected to Raman spectroscopy. The spectrum (A) thus obtained is shown in FIG. 1. Raman spectroscopy was carried out after the film sample (film thickness: about 0.5 μm) was stored for at least 24 hours at 25° C. and RH 50%. This will equally apply to Examples and Comparative Example described later.

As a result of Raman spectroscopy, in a Raman shift range of from 300 to 3100 cm⁻¹, the highest intensity peak existed at 700 cm⁻¹ and its peak intensity was 3230. A peak attributable to —C═C— existed at 1655 cm⁻¹ and its peak intensity was about 400.

After the film was heated at 200° C. for 60 seconds on a hot plate in a nitrogen gas stream to remove the solvent by drying, it was baked for 60 minutes in an oven of 400° C. purged with nitrogen, whereby a 0.5-μm thick uniform film without blisters was obtained.

The dielectric constant of the film calculated from the capacitance value at 1 MHz by using a mercury probe manufactured by Four Dimensions and “HP4285A LCR meter” (trade name; product of Yokogawa Hewlett Packard) was 2.42. A Young's modulus of the film as measured by “Nanoindenter SA2” (trade name; product of MTS) was 8.0 GPa. The dielectric constant and Young' modulus were each measured at 25° C. This will equally apply to the following Examples and Referential Example.

A portion of the film was chipped off and subjected to Raman spectroscopy. The spectrum (B) thus obtained is shown in FIG. 2. As a result of Raman spectroscopy, in a Raman shift range of from 300 to 3100 cm⁻¹, the highest intensity peak existed at 700 cm⁻¹ and its peak intensity was about 1760. A peak attributable to —C═C— existed at 1630 cm⁻¹ and its peak intensity was about 800. Raman spectroscopy was performed using a YAG laser (wavelength: 1064 nm), “PDP-320 Spectroscope” manufactured by Photon Design, and InGaAs detector.

### Example 2

Under a nitrogen gas stream, 2 g of 4,9-diethynyldiamantane, 0.8 g of 1,1′-azobis(cyclohexane-1-carbonitrile (“V-40”, trade name; product of Wako Pure Chemicals) and 10 ml of dichlorobenzene were polymerized by stirring them for 8 hours at an internal temperature of 100° C. After the reaction mixture was cooled to room temperature, 100 ml of methanol was added. The solid thus precipitated was collected by filtration and washed with methanol, whereby 1.0 g of Polymer (B) having a mass-average molecular weight of about 10000 was obtained. The solubility of Polymer (B) in cyclohexanone was 15 mass % or greater at 25° C.

A coating solution was prepared by completely dissolving 1.0 g of Polymer (B) in 10 g of cyclohexanone. The resulting solution was filtered through a 0.1 μm filter made of tetrafluoroethylene, followed by spin coating on a silicon wafer, whereby a film was obtained.

A portion of the film was chipped off and subjected to Raman spectroscopy in the same way as in Example 1. As a result of Raman spectroscopy, in a Raman shift range of from 300 to 3100 cm⁻¹, the highest intensity peak existed at 700 cm⁻¹ and its peak intensity was about 2900. A peak attributable to —C═C— existed at 1655 cm⁻¹ and its peak intensity was about 450.

After the film was heated at 250° C. for 60 seconds on a hot plate in a nitrogen gas stream, it was baked for 60 minutes in an oven of 400° C. purged with nitrogen, whereby a 0.5-μm thick uniform film without blisters was obtained. The resulting film had a dielectric constant of 2.43 and Young's modulus of 7.8 GPa.

A portion of the film was chipped off and subjected to Raman spectroscopy in the same way as in Example 1. As a result, in a Raman shift range of from 300 to 3100 cm⁻¹, the highest intensity peak existed at 699 cm⁻¹ and its peak intensity was about 1200. A peak attributable to —C═C— existed at 1627 cm⁻¹ and its peak intensity was about 650.

### Example 3

In a similar manner to Example 1 except for the use of 1,6-diethynyldiamantane instead of 4,9-diethynyldiamantane, 0.9 g of Polymer (C) was synthesized. As a result of GPC measurement, the polymer had a mass-average molecular weight of about 20000.

The solubility of Polymer (C) in cyclohexanone was 15 mass % or greater at 25° C.

A 10 mass % solution of the polymer in cyclohexanone was prepared and filtered through a 0.2 μm filter made of TFE, followed by spin coating on a silicon wafer, whereby a film was obtained.

A portion of the film was chipped off and subjected to Raman spectroscopy in the same way as in Example 1. As a result, in a Raman shift range of from 300 to 3100 cm⁻¹, the highest intensity peak existed at 750 cm⁻¹ and its peak intensity was about 2000. A peak attributable to —C═C— existed at 1655 cm⁻¹ and its peak intensity was about 500. The film was baked at 400° C. for 60 seconds in a furnace purged with nitrogen. As a result, a 0.5-μm thick uniform film without blisters was obtained.

The film thus obtained had a dielectric constant 2.37 and Young's modulus of 7.5 GPa. A portion of the film was chipped off and subjected to Raman spectroscopy in the same way as in Example 1. As a result, in a Raman shift range of from 300 to 3100 cm⁻¹, the highest intensity peak existed at 748 cm⁻¹ and its peak intensity was about 1200. A peak attributable to —C═C— existed at 1650 cm⁻¹ and its peak intensity was about 450.

### Comparative Example 1

In accordance with the method described in Example 1 of U.S. Pat. No. 6,359,091, an oligomer solution was prepared. The resulting solution was filtered through a 0.2 μm filter made of TFE, followed by spin coating on a silicon wafer, whereby a film was obtained.

A portion of the film was chipped off and subjected to Raman spectroscopy in the same way as in Example 1. As a result, in a Raman shift range of from 300 to 3100 cm⁻¹, the highest intensity peak existed at 1600 cm⁻¹ and its peak intensity was about 1500.

The film was baked at 400° C. for 60 seconds in a furnace purged with nitrogen. A 0.5-μm thick uniform film without blisters was obtained. The resulting film had a dielectric constant of 2.68 and a Young's modulus of 3.0 GPa.

A portion of the film was chipped off and subjected to Raman spectroscopy in the same way as in Example 1. As a result, in a Raman shift range of from 300 to 3100 cm⁻¹, the highest intensity peak existed at 1600 cm⁻¹ and its peak intensity was about 1200.

Evaluation results of the above-described Examples and Comparative Example are shown in 1.

TABLE 1

| | | Results of Raman spectroscopy | | | | Physical properties | |
|---|---|---|---|---|---|---|---|
| | | Position of | Intensity of | Peak | | of film | |
| | | highest | highest | intensity | Peak | | Young's |
| | | intensity peak | intensity | near 1600 | intensity | Dielectric | modulus |
| | | (cm⁻¹) | peak | cm⁻¹ | ratio | constant | (GPa) |
| Ex. 1 | Before | 700 | 3230 | 430 | 0.13 | — | — |
| | curing | | | | | | |
| | After | 700 | 1760 | 800 | 0.46 | 2.42 | 8.0 |
| | curing | | | | | | |
| Ex. 2 | Before | 700 | 2900 | 450 | 0.16 | — | — |
| | curing | | | | | | |
| | After | 699 | 1200 | 650 | 0.54 | 2.43 | 7.8 |
| | curing | | | | | | |
| Ex. 3 | Before | 750 | 2000 | 500 | 0.25 | — | — |
| | curing | | | | | | |
| | After | 748 | 1200 | 450 | 0.38 | 2.37 | 7.5 |
| | curing | | | | | | |
| Comp. | Before | 1600 | 1500 | Same on | — | — | — |
| Ex. 1 | curing | | | the left | | | |
| | After | 1600 | 1200 | Same on | — | 2.68 | 3.0 |
| | curing | | | the left | | | |

The results have revealed that the films of the invention having Raman spectrum properties are superior in both dielectric constant and Young's modulus to the film obtained in Comparative Example; and that the polymers used in Examples 1 to 3 have a higher solubility in a solvent, facilitate formation of a film by spin coating, and do not generate blisters.

Use of the film forming composition of the invention makes it possible to provide a film suited as an interlayer insulating film in electronic devices, excellent in heat resistance and mechanical strength and having a low dielectric constant.

The entire disclosure of each and every foreign patent application from which the benefit of foreign priority has been claimed in the present application is incorporated herein by reference, as if fully set forth.

What is claimed is:

1. A film having, as a result of Raman spectroscopy, the highest intensity peak within from 690 to 800 cm⁻¹ in a Raman shift range of from 300 to 3100 cm⁻¹.

2. The film according to claim 1,
wherein the highest intensity peak is attributable to a —C—C— bond.

3. The film according to claim 1,
wherein, as a result of Raman spectroscopy, a peak intensity existing within from 1500 to 2000 cm⁻¹ attributable to a —C═C— bond or aromatic structure is not greater than 0.7 time the highest peak intensity in a Raman shift range of from 300 to 3100 cm⁻¹.

4. The film according to claim 1, which comprises a compound having a cage structure.

5. The film according to claim 4,
wherein the compound having a cage structure is a polymer of a monomer having a cage structure.

6. The film according to claim 4,
wherein the monomer having a cage structure has a polymerizable carbon-carbon double bond or carbon-carbon triple bond.

7. The film according to claim 4,
wherein the cage structure is selected from the group consisting of adamantane, biadamantane, diamantane, triamantane and tetraamantane.

8. The film according to claim 5,
wherein the monomer having a cage structure is a compound represented by any one of formulas (I) to (VI): 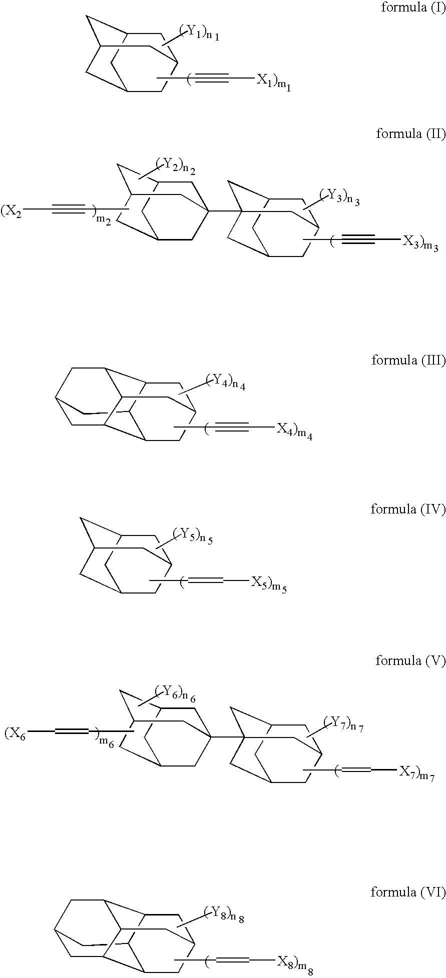
wherein, X₁ to X₈ each independently represents a hydrogen atom, alkyl group, alkenyl group, alkynyl group, aryl group, silyl group, acyl group, alkoxycarbonyl group or carbamoyl group;
Y₁ to Y₈ each independently represents an alkyl group, aryl group or silyl group;
m₁ and m₅ each independently represents an integer of from 1 to 16;
n₁ and n₅ each independently represents an integer of from 0 to 15;
m₂, m₃, m₆ and m₇ each independently represents an integer of from 1 to 15;
n₂, n₃, n₆ and n₇ each independently represents an integer of from 0 to 14;
m₄ and m₈ each independently represents an integer of from 1 to 20; and
n₄ and n₈ each independently represents an integer of from 0 to 19.

9. The film according to claim 4,
wherein the compound having a cage structure is obtained by polymerizing monomers having a cage structure in the presence of a transition metal catalyst or a radical initiator.

10. The film according to claim 4,
wherein the compound having a cage structure has a solubility at 25° C. of 3 mass % or greater in cyclohexanone or anisole.

11. The film according to claim 1, which has insulation properties obtained by baking.

12. An electronic device comprising a film according to claim 1.

13. A film forming composition comprising an organic solvent and capable of providing a film according to claim 1.

14. The film forming composition according to claim 13, comprising a compound having a cage structure.

15. The film forming composition according to claim 14,
wherein the compound having a cage structure is a polymer of a monomer having a cage structure.

16. The film forming composition according to claim 15,
wherein the monomer having a cage structure has a polymerizable carbon-carbon double bond or carbon-carbon triple bond.

17. The film forming composition according to claim 14,
wherein the cage structure is selected from the group consisting of adamantane, biadamantane, diamantane, triamantane and tetraamantane.

18. The film forming composition according to claim 15,
wherein the monomer having a cage structure is a compound represented by any one of formulas (I) to (VI): 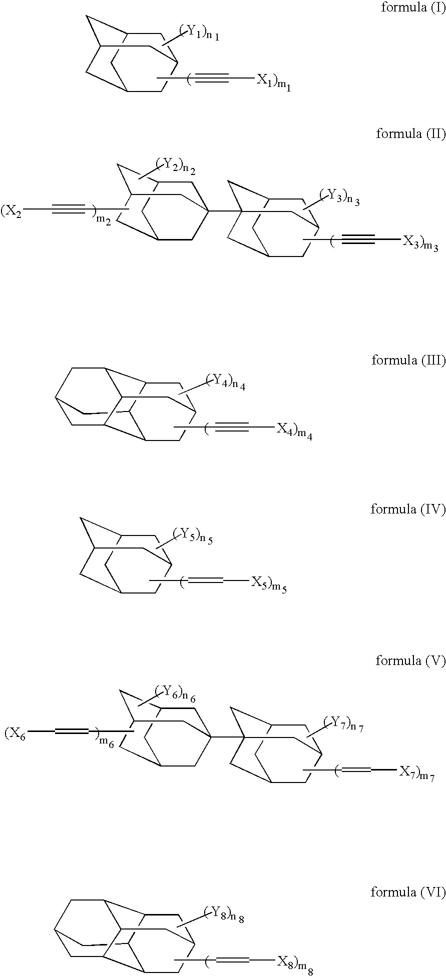
wherein, X₁ to X₈ each independently represents a hydrogen atom, alkyl group, alkenyl group, alkynyl group, aryl group, silyl group, acyl group, alkoxycarbonyl group or carbamoyl group;
Y₁ to Y₈ each independently represents an alkyl group, aryl group or silyl group;
m₁ and m₅ each independently represents an integer of from 1 to 16;
n₁ and n₅ each independently represents an integer of from 0 to 15;
m₂, m₃, m₆ and m₇ each independently represents an integer of from 1 to 15;
n₂, n₃, n₆ and n₇ each independently represents an integer of from 0 to 14;
m₄ and m₈ each independently represents an integer of from 1 to 20; and
n₄ and n₈ each independently represents an integer of from 0 to 19.

19. The film forming composition according to claim 15,
wherein the compound having a cage structure is obtained by polymerizing the monomer having a cage structure in the presence of a transition metal catalyst or a radical initiator.

20. The film forming composition according to claim 15,
wherein the compound having a cage structure has a solubility at 25° C. of 3 mass % or greater in cyclohexanone or anisole.
